(19) United States
(12) Patent Application Publication
(10) Pub. No.: US 2005/0179657 A1
(43) Pub. Date: Aug. 18, 2005

(54) System and method of emulating mouse operations using finger image sensors

(75) Inventors: Anthony P. Russo, New York, NY (US); Ricardo Dario Pradenas, Santa Cruz, CA (US); David L. Weigand, Santa Clara, CA (US)

Correspondence Address: HAVERSTOCK & OWENS LLP, 162 NORTH WOLFE ROAD, SUNNYVALE, CA, 94086, US

(73) Assignee: Atrua Technologies, Inc.

(21) Appl. No.: 11/056,820

(22) Filed: Feb. 10, 2005

Related U.S. Application Data
(63) Continuation-in-part of application No. 10/873,393, filed on Jun. 21, 2004.
(60) Provisional application No. 60/544,477, filed on Feb. 12, 2004.

(51) Int. Cl. G09G 5/08

(52) U.S. Cl. 345/163

(57) ABSTRACT

A system and method in accordance with the present emulate a computer mouse operation. The system comprises a finger image sensor for capturing images relating to a finger and generating finger image data, a controller, and an emulator. The controller is coupled to the finger image sensor and is configured to receive the finger image data and generate movement and presence information related to the finger on the finger image sensor. The emulator is configured to receive the movement and presence information, determine duration corresponding to the presence of the finger on the finger image sensor, and generate data corresponding to a mouse output. In a preferred embodiment, the finger image sensor comprises one or more logical regions, each region corresponding to a positional mouse button. In this way, the system is able to emulate a left mouse click and, optionally, a right mouse click and a center mouse click.

### RELATED APPLICATIONS

This application claims priority under 35 U.S.C. § 119(e) of the co-pending U.S. provisional application Ser. No. 60/544,477 filed on Feb. 12, 2004, and titled “SYSTEM AND METHOD FOR EMULATING MOUSE OPERATION USING FINGER IMAGE SENSORS.” The provisional application Ser. No. 60/544,477 filed on Feb. 12, 2004, and titled “SYSTEM AND METHOD FOR EMULATING MOUSE OPERATION USING FINGER IMAGE SENSORS,” is hereby incorporated by reference. This application is also a continuation-in-part of the co-pending U.S. patent application Ser. No. 10/873,393, filed on Jun. 21, 2004, and titled “SYSTEM AND METHOD FOR A MINIATURE USER INPUT DEVICE,” which is hereby incorporated by reference.

### FIELD OF THE INVENTION

The present invention relates to computer input devices. More particularly, the present invention relates to the use of finger image sensors to emulate computer input devices such as electronic mice.

### BACKGROUND OF THE INVENTION

The emergence of portable electronic computing platforms allows functions and services to be enjoyed wherever necessary. Palmtop computers, personal digital assistants, mobile telephones, portable game consoles, biometric/health monitors, and digital cameras are some everyday examples of the many portable electronic computing platforms. The desire for portability has driven these computing platforms to become smaller and have longer battery life. A dilemma occurs when these ever-smaller devices require efficient ways to collect user input.

Portable electronic computing platforms need these user input methods for multiple purposes:
a. Navigation: moving a cursor or a pointer to a certain location on a display.
b. Selection: choosing (or not choosing) an item or an action.
c. Orientation: changing direction with or without visual feedback.

Concepts for user input from much larger personal computers have been borrowed. Micro joysticks, navigation bars, scroll wheels, touchpads, steering wheels and buttons have all been adopted, with limited success, in present day portable electronic computing platforms. All of these devices consume substantial amounts of valuable surface real estate on a portable device. Mechanical devices such as joysticks, navigation bars and scroll wheels can wear out and become unreliable. Because they are physically designed for a single task, they typically do not provide functions of other navigation devices. Their sizes and required movements often preclude optimal ergonomic placement on portable computing platforms. Moreover, these smaller versions of their popular personal computer counterparts usually do not offer accurate or high-resolution position information, since the movement information they sense is too coarsely grained.

Some prior art solutions use finger image sensors for navigation. For example, U.S. Pat. No. 6,408,087 to Kramer, titled “Capacitive Semiconductor User Input Device,” discloses using a fingerprint sensor to control a cursor on the display screen of a computer. Kramer describes a system that controls the position of a pointer on a display according to detected motion of the ridges and pores of the fingerprint. However, Kramer fails to describe how to implement other aspects of mouse operations, such as a click, given the constraints of a finger image sensor.

### SUMMARY OF THE INVENTION

The systems and methods of the present invention use a finger image sensor to emulate mouse operations such as drag and drop, and positional mouse clicks, including left mouse clicks, right mouse clicks, and center mouse clicks. Finger image sensors are well-suited for use on portable electronic devices because they are smaller than mechanical mice, are more durable because they use no moving parts, and are cheaper.

In a first aspect of the present invention, a system for emulating mouse operations comprises a finger image sensor for capturing images relating to a finger. The finger image sensor is coupled to a controller, which in turn is coupled to an emulator. The finger image sensor takes the captured images and generates finger image data. The controller receives the finger image data and generates information related to movement and presence of the finger on the finger image sensor. The emulator receives the movement and presence information, determines durations corresponding to the presence of the finger on the finger image sensor, and generates data corresponding to a mouse operation. In a preferred embodiment, the finger image sensor comprises one or more logical regions each corresponding to a positional mouse button.

In one embodiment, the emulator is configured to determine that a finger is off the finger image sensor for a predetermined duration and that the finger is maintained within an area of a first region from the one or more logical regions for a time within a predetermined range of durations. Preferably, the emulator is configured to generate data corresponding to a single mouse click in the event that the finger is off the finger image sensor for at least a first predetermined duration, the finger is maintained within the area of the first region within a first predetermined range of durations, and the finger is off the finger image sensor for at least a second predetermined duration. In one embodiment, the first and second predetermined durations are approximately 2 seconds. The first and second predetermined ranges of durations is 10 ms to 2 seconds, and the second predetermined duration is approximately 2 seconds. The present invention can be implemented using first and second durations that are the same or different.

In one embodiment, it is determined that the finger is maintained within the area of the first region if the finger has moved no more than a first linear distance in a first direction within the first region and no more than a second linear distance in a second direction within the first region. In one embodiment, the first linear distance and the second linear distance are approximately 10 mm. Preferably, the first linear distance and the second linear distance are determined using a row-based correlation.

In one embodiment, the one or more logical regions comprise a left region corresponding to a left mouse button such that the single mouse click corresponds to a left mouse button click. In another embodiment, the one or more logical regions further comprise at least one of a right region corresponding to a right mouse button and a center region corresponding to a center mouse button.

In another embodiment, the emulator is configured to generate data corresponding to a double mouse click in the event that the finger is off the finger image sensor for at least a first predetermined duration, the finger is maintained within an area of the first region within a first predetermined range of durations, the finger is off the finger image sensor for at least the second predetermined duration, the finger is maintained within the area of the first region within a third predetermined range of durations, and the finger is off the finger image sensor for at least a third predetermined duration.

In another embodiment, the emulator is further configured to generate data corresponding to relocating an object displayed on a screen. The data corresponding to relocating the object comprises first data corresponding to selecting the object using an onscreen cursor, second data corresponding to capturing the object, third data corresponding to moving the object along the screen, and fourth data corresponding to unselecting the object. The first data are generated by moving the finger across the finger image sensor and tapping the finger image sensor. The second data are generated by placing and maintaining the finger within the area of the first region for a predetermined time. The third data are generated by moving the finger across the finger image sensor. And the fourth data are generated by tapping the finger on the finger image sensor.

In another embodiment, the system further comprises an electronic device having a screen for displaying data controlled by the mouse operation. The electronic device is any one of a portable computer, a personal digital assistant, and a portable gaming device.

Preferably, the finger image sensor is a swipe sensor, such as a capacitive sensor, a thermal sensor, or an optical sensor. Alternatively, the finger image sensor is a placement sensor.

In a second aspect of the present invention, a method of emulating an operation of a mouse comprises determining a sequence of finger placements on and off a finger image sensor and their corresponding durations and using the sequence and corresponding durations to generate an output for emulating a mouse operation.

### BRIEF DESCRIPTION OF THE DRAWINGS

FIG. 1 is a logical block diagram of a system using a finger image sensor to emulate a mouse in accordance with the present invention.

FIG. 2 illustrates a finger image sensor logically divided into left, center, and right regions.

FIG. 3 is a flow chart depicting the steps used to generate a mouse click event from a finger image sensor in accordance with the present invention.

FIG. 4 is a flow chart depicting the steps used to generate a double mouse click event from a finger image sensor in accordance with the present invention.

FIG. 5 is a flow chart depicting the steps used to drag and drop an object using a finger image sensor in accordance with the present invention.

FIG. 6 is a flow chart depicting the steps used to drag and drop multiple objects using a finger image sensor in accordance with the present invention.

### DETAILED DESCRIPTION OF THE PREFERRED EMBODIMENT

In accordance with the present invention, a system and method use a finger image sensor to emulate mouse operations such as drag-and-drop and mouse clicks. Advantageously, the system has no mechanical moving components that can wear out or become mechanically miscalibrated. Because finger image sensors can be configured to perform multiple operations, the system is able to use the finger image sensor to emulate a mouse in addition to performing other operations, such as verifying the identity of a user, emulating other computer devices, or performing any combination of these other operations.

Systems and methods in accordance with the present invention have several other advantages. For example, the system and method are able to be used with any type of sensor. In a preferred embodiment, the system uses a swipe sensor because it is smaller than a placement sensor and can thus be installed on smaller systems. Small sensors can be put almost anywhere on a portable device, allowing device designers to consider radically new form factors and ergonomically place the sensor for user input. The system and method are flexible in that they can be used to generate resolutions of any granularity. For example, high-resolution outputs can be used to map small finger movements into large input movements. The system and method can thus be used in applications that require high resolutions. Alternatively, the system and method can be used to generate resolutions of coarser granularity. For example, low-resolution sensors of 250 dots per inch (dpi) or less can be used to either reduce the cost or improve sensitivity.

Embodiments of the present invention emulate mouse operations by capturing finger image data, including but not limited to ridges, valleys and minutiae, and using the data to generate computer inputs for portable electronic computing platforms. By detecting the presence of a finger and its linear movements, embodiments are able to emulate the operation of a mouse using a single finger image sensor.

The system in accordance with the present invention produces a sequence of measurements called frames. A frame or sequence of frames can also be referred to as image data or fingerprint image data. While the embodiments described below use a swipe sensor, one skilled in the art will recognize that placement sensors or any other type of sensor for capturing fingerprint images or finger position can also be used in accordance with the present invention. Moreover, sensors of any technology can be used to capture finger image data including, but not limited to, capacitive sensors, thermal sensors, and optical sensors.

FIG. 1 illustrates a system 100 that uses a finger image sensor 101 to emulate mouse operations in accordance with the present invention. The system 100 comprises the finger image sensor 101 coupled to a group of instruments 110, which in turn is coupled to a computing platform 120. In a preferred embodiment, the finger image sensor 101 is a swipe sensor, such as the Atrua ATW100 capacitive swipe sensor. Alternatively, the finger image sensor 101 is a placement sensor.

In operation, the finger image sensor 101 captures an image of a finger and transmits raw image data 131 to the group of instruments 110. The group of instruments comprises a linear movement correlator 111 and a finger presence detector 112, both of which are coupled to the finger image sensor 101 to receive the raw image data 131. The linear movement correlator 111 receives successive frames of the raw image data 131 and generates data corresponding to finger movement across the finger image sensor 101 between two successive frames in two orthogonal directions, ΔX 132 and ΔY 133. ΔX 132 is the finger movement in the x-dimension and ΔY 133 is the finger movement in the y-dimension. In the preferred embodiment, the x-dimension is along the width of the finger image sensor 101 and the y-dimension is along the height of the finger image sensor 101. It will be appreciated, however, that this definition of x- and y-dimensions is arbitrary and does not affect the scope and usefulness of the invention. The finger presence detector 112 receives the same successive frames of the raw image data 131 and generates finger presence information 134, used to determine whether a finger is present on the finger image sensor 101.

The computing platform 120 comprises a mouse emulator 121, which is configured to receive ΔX 132 and ΔY 133 information from the linear movement correlator 111 and the finger presence information 134 from the finger presence detector 112. The mouse emulator 121 generates a pointerX position 150, a pointerY position 151, and a click event 152, all of which are described in more detail below.

The computing platform 120, which represents a portable host computing platform, includes a central processing unit and a memory (not shown) used by the mouse emulator 121 to emulate mouse operations. For example, the mouse emulator 121 generates a click event 152 that an operating system configured to interface with computer input devices, such as a mouse, uses to determine that a mouse click has occurred. The operating system then uses the pointerX position 150 (the movement in the x-direction) and the pointerY position 151 (the movement in the y-direction) to determine the location of the mouse pointer.

In a preferred embodiment, ΔX 132 and ΔY 133 are both calculated using row-based correlation methods. Row-based correlation methods are described in U.S. patent application Ser. No. 10/194,994, titled “Method and System for Biometric Image Assembly from Multiple Partial Biometric Frame Scans,” and filed Jul. 12, 2002, which is hereby incorporated by reference. The '994 application discloses a row-based correlation algorithm that detects ΔX 132 in terms of rows and ΔY 133 in terms of pixels. The finger displacement (i.e., movement) is calculated without first calculating the speed of movement. An additional benefit of the row-based algorithm is that it detects movement between successive rows with only one or two finger ridges captured by the finger image sensor 101, without relying on pores.

The finger presence detector 112 analyzes the raw image data 131 to determine the presence of a finger. The '994 application discloses a number of finger presence detection rules based on measuring image statistics of a frame. These statistics include the average value and the variance of an entire collected frame, or only a subset of the frame. The frame can be considered to contain only noise rather than finger image data, if (1) the frame average is equal to or above a high noise average threshold value, (2) the frame average is equal to or below a low noise average threshold value, or (3) the frame variance is less than or equal to a variance average threshold value. The '994 application also defines the rules for the finger presence detector 112 to operate on an entire finger image sensor. One skilled in the art will appreciate that the rules are equally applicable to any region of a finger image sensor. The finger presence detector 112 generates finger presence information 134 for a region by applying the same set of finger presence detection rules for the region. If the variance is above a threshold and the mean pixel value is below a threshold, a finger is determined to be present in that region. If not, the finger is not present.

The mouse emulator 121 collects ΔX 132 and ΔY 133 and finger presence information 133 to emulate the operation of a mouse. The mouse emulator 121 is able to emulate two-dimensional movements of a mouse pointer, clicks and drag-and-drop. The movements ΔX 132 and ΔY 133, generated by the linear movement correlator 111, are scaled non-linearly in multiple stages to map to the pointer movements on a viewing screen.

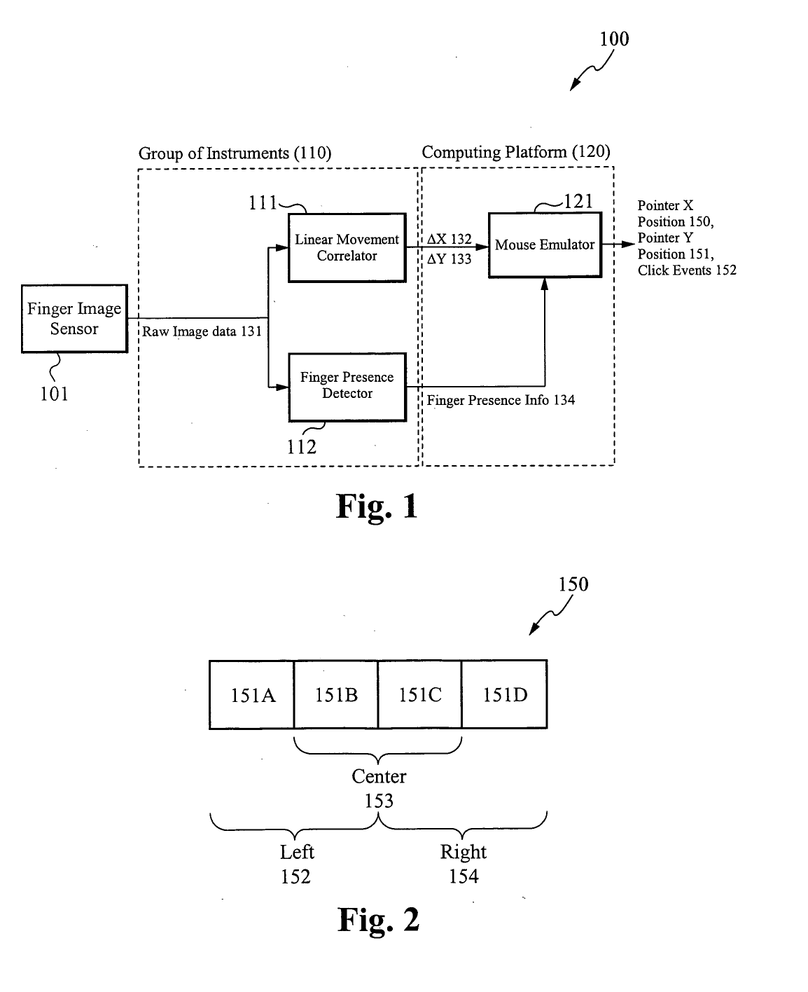

Mouse clicks are integral parts of mouse operations. In the preferred embodiment, a sequence of finger absence to finger presence transitions along with minimal finger movement signifies a single click. FIG. 2 shows a finger image sensor 150 that has a plurality of logical regions 151A-D. The finger image sensor 150 is used to explain left-, center-, and right-clicks for emulating a mouse in accordance with the present invention. As described in more detail below, the regions 151A and 151B together correspond to a left-mouse button 152, such that pressing or tapping a finger on the regions 151A and 151B corresponds to (e.g., will generate signals and data used to emulate) pressing or tapping a left mouse button. In a similar manner, the regions 151B and 151C correspond to a center mouse button 153, and the regions 151C and 151D correspond to a right mouse button 154. It will be appreciated that while FIG. 2 shows the finger image sensor 150 divided into four logical regions 151A-D, the finger image sensor 150 is able to be divided into any number of logical regions corresponding to any number of mouse buttons.

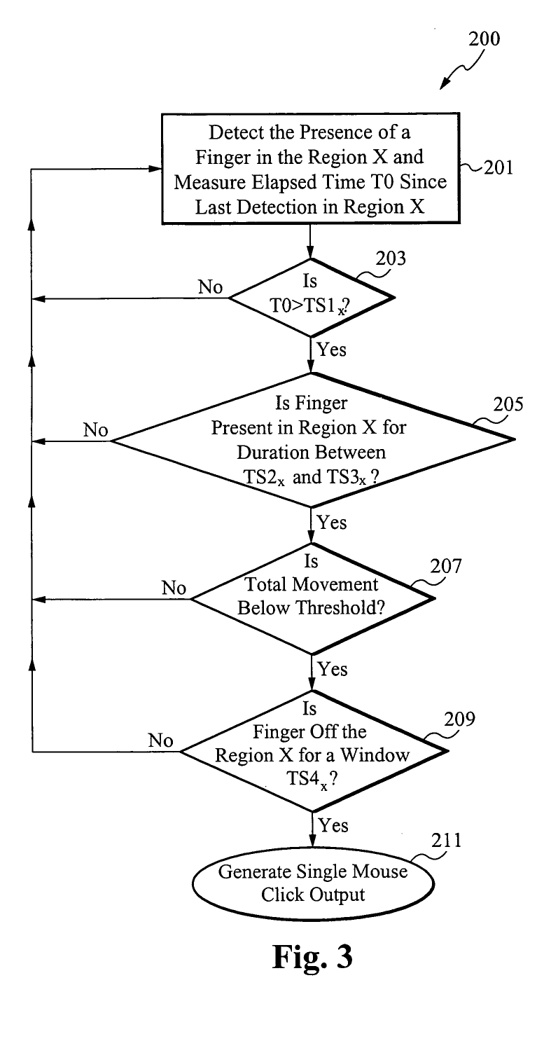

FIG. 3 is a flow chart showing process steps 200 performed by the mouse emulator 121 and used to translate finger image data into data corresponding to mouse clicks in accordance with the present invention. The steps 200 are used to emulate clicking a mouse by pressing or tapping a finger within any region X of the finger image sensor 101. In one example, X is any one of a left region (L region 152 in FIG. 2) corresponding to a left mouse click; a center region © region 153 in FIG. 2) corresponding to a center mouse click; and a right region® region 154 in FIG. 2) corresponding to a right mouse click. Embodiments of the present invention are said to support “regional clicks” because they are able to recognize and thus process clicks based on the location of finger taps (e.g., occurrence within a region L, C, or R) on the finger image sensor 101.

In the step 201, a process in accordance with the present invention (1) determines whether a finger has been present within a region X and (2) calculates the time T0 that has elapsed since a finger was detected in the region X. Next, in the step 203, the process determines whether T0 is greater than a predetermined time TS1_{X}. If T0 is greater than TS1_{X}, then the process immediately (e.g., before any other sequential steps take place) continues to the step 205; otherwise, the process loops back to the step 201. The step 203 thus ensures that there is sufficient delay between taps on the finger image sensor 101.

In the step 205, the process determines whether the finger is present within the region X for a duration between the predetermined durations TS2_{X} and TS3_{X}. If the finger is present within the region X for this duration, the process continues to the step 207; otherwise, the process loops back to the step 201. In the step 207, the process determines whether, when the finger is present on the finger image sensor 101 during the step 205, the total finger movement is below a predetermined threshold D_{MAX}. The processing in the step 207 ensures that the finger does not move more than a defined limit while on the finger image sensor 101. If the finger movement is below the predetermined threshold D_{MAX}, the process immediately continues to the step 209; otherwise, the process loops back to the step 201.

In the step 209, the process determines whether the finger is outside the region X of the finger image sensor 101 for a duration of TS4_{X}. If it is, then processing continues to the step 211; otherwise, the process loops back to the step 201. Referring to FIGS. 1 and 3, in the step 211, a single mouse click event 152 is generated, and the pointerX position 150 and the pointerY position 152 are both made available to the operating system to emulate a single click of a mouse.

In some embodiments, TS1_{X}, TS2_{X}, TS3_{X}, and TS4_{X} all have values that range between 10 ms and 2 seconds, for all X (e.g., L, R, and C); and D_{MAX} has an x component MSX and a y component MSY, both of which can be set to any values between 0 mm to 100 mm, for all X. In a preferred embodiment, TS1_{X}=300 ms, TS2_{X}=200 ms, TS3_{X}=2,000 ms, TS4_{X}=200 ms, MSX=10 mm and MSY=10 mm, for all X. It will be appreciated that other values can be used to fit the application at hand.

It will further be appreciated that the durations and thresholds can have values that depend on the value of X. For example, in one embodiment, TS1_{L}=300 ms (i.e., X=L, corresponding to a finger present in the left region 152), TS1_{C}=400 ms (i.e., X=C, corresponding to a finger present in the center region 153), and TS1_{R}=150 ms (i.e., X=R, corresponding to a finger present in the right region 154).

Regional clicks emulate left, center and right mouse clicks. As illustrated in FIG. 2, the regions L 152, C 153, and R 154 are of equal size and the center region C 153 is exactly in the center of the finger image sensor 101. One skilled in the art will appreciate that any number of regions of unequal sizes can be used; a center region does not need to be exactly in the center of the finger image sensor 101; and the regions 152-154 do not have to overlap.

In a preferred embodiment, the finger presence information 133 for each region 152-154 is calculated separately. A finger can be simultaneously detected in one, two, or multiple regions 152-154. In the preferred embodiment, only one click is allowed at a time. If a finger is detected in more than one region 152-154, then the region with the highest variance and lowest mean is considered to have a finger present. In another embodiment, if a finger is detected in more than one region 152-154, it is determined that the finger is present in the center region R 153. This determination is arbitrary. For example, in an alternative embodiment, if a finger is detected in more than one region 152-154, it can be determined that the finger is present in any one of the left region 152 and the right region 154.

In an alternative embodiment, a priority is assigned to each region 152-154. If a finger is detected in more than one region, then the region with the highest priority is considered to have a finger present.

It will be appreciated that some applications use only a single mouse button. Referring to FIG. 2, in these applications, the regions 152-154 can be mapped to correspond to any number of positional mouse clicks. For example, for those applications that only recognize a left mouse button, a click in any region 152-154 will be used to emulate a left mouse button click.

In another embodiment, simultaneous clicks are allowed. If a finger is detected in more than one region 152-154, then all regions 152-154 are considered to have a finger present. If the timing requirements and movement restrictions are met, then multiple clicks can be generated simultaneously.

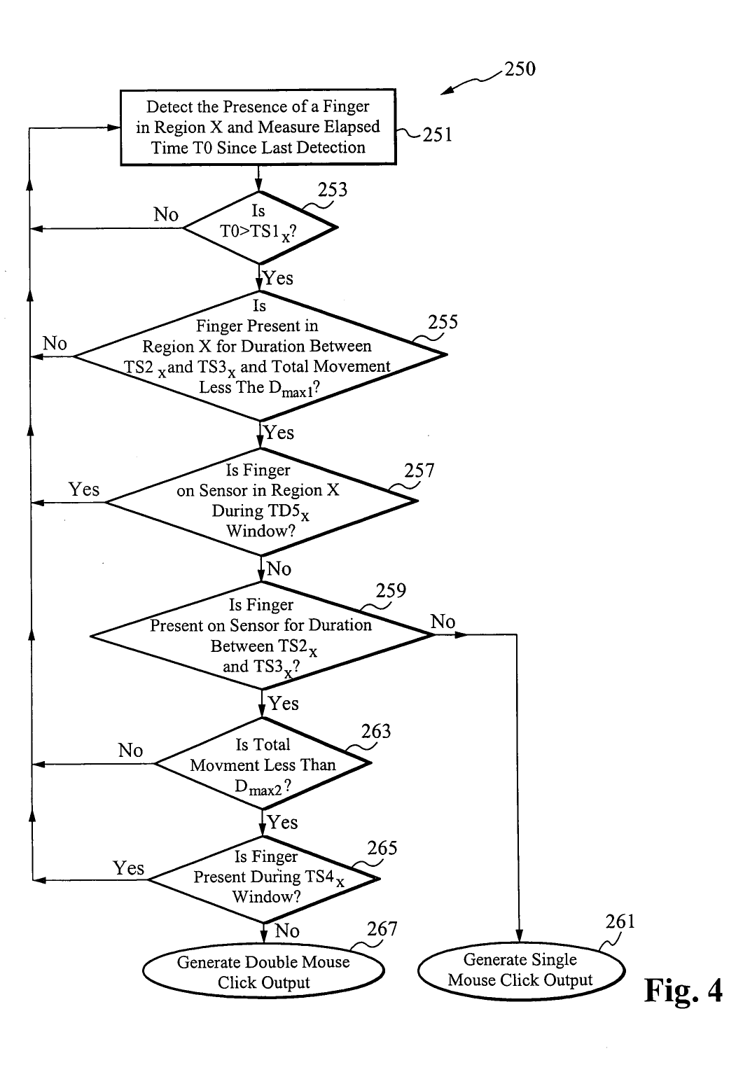

Embodiments of the present invention also recognize multiple clicks. A double click is similar to a single click, except that the presence of a finger in a region 152-154 is checked shortly after a single click. FIG. 4 illustrates the steps 250 of a process for emulating a double click in accordance with the present invention.

In the step 251, the process (1) determines whether a finger has been present within a region X on the finger image sensor 101 and (2) calculates the time T0 that has elapsed since a finger was detected in the region X. As in the discussion of FIGS. 2 and 3, X is any one of L (the left region 152, FIG. 2), C (the center region 153), and R (the right region 154). Next, in the step 253, the process determines whether T0 is greater than a predetermined time TS1_{X}. If T0 is greater than TS1_{X}, then the process immediately (e.g., before any other sequential steps take place) continues to the step 255; otherwise, the process loops back to the step 251.

In the step 255, the process determines whether (1) the finger is present within the region X for a duration between the predetermined durations TS2_{X} and TS3_{X} and (2) the total movement of the finger within the region X is less than a threshold value D_{MAX1}. If the finger is present within the region X for this duration, and the total finger movement is less than D_{MAX1}, then the process immediately continues to the step 257; otherwise, the process loops back to the step 251. In the step 257, the process determines whether the finger is present in the region X for a duration of TD5_{X}. If the finger has been in the region X during the window TD5_{X}, then the process loops back to the step 251; otherwise, the process continues to the step 259.

In the step 259, the process determines whether the finger has been present in the region X for a duration between TS2_{X} and TS3_{X}. If the finger has not been present in the region X for this duration, the process continues to the step 261; otherwise, the process continues to the step 263. In the step 261, the process outputs a single mouse click event and the pointerX position and the pointerY position, similar to the output generated in the step 211 of FIG. 3. In the step 263, the process determines whether the total movement of the finger in the region X is below a predetermined threshold D_{MAX2}. If the total movement is less than D_{MAX2}, then the process continues to the step 265; otherwise, the process loops back to the step 251.

In the step 265, the process determines whether the finger has been in the region X during a window of TS4_{X} duration. If the finger has been in the region X during this window, the process loops back to the step 251; otherwise, the process continues to the step 267, in which a double click mouse event is generated, and the pointerX position 150 and the pointerY position 152 are both made available to the operating system, to be used if needed.

In a preferred embodiment, TD5_{X}=300 ms, for all values of X (L, C, and R). It will be appreciated that other values of TD5_{X} can be used. Furthermore, the values of TD5_{X} can vary depending on the value of X, that is, the location of the finger on the finger image sensor 101. For example, TD5_{L} can have a value different from the value of TD5_{R}.

In another embodiment, the mouse emulator 121 generates only single mouse clicks. The application program executing on a host system and receiving the mouse clicks interprets sequential mouse clicks in any number of ways. In this embodiment, if the time period between two mouse clicks is less than a predetermined time, the application program interprets the mouse clicks as a double mouse click. In a similar way, the application program can be configured to receive multiple mouse clicks and interpret them as a single multiple-click.

Other embodiments of the present invention are used to interpret emulated mouse operations in other ways. For example, in one embodiment, the mouse emulator 121 determines that a finger remains present on the mouse button during a predetermined window. An application program receiving the corresponding mouse data interprets this mouse data as a “key-down” operation. Many application programs recognize a key down operation as repeatedly pressing down the mouse button or some other key.

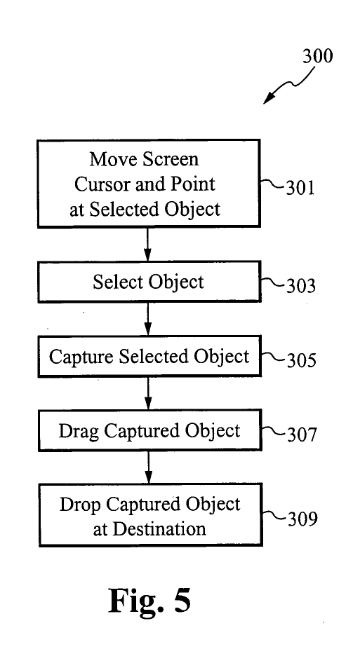

Embodiments of the present invention are also able to emulate other mouse operations such as capturing an object displayed at one location on a computer screen and dragging the object to a different location on the computer screen, where it is dropped. Here, an object is anything that is displayable and movable on a display screen, including files, folders, and the like. Using a standard mouse, drag and drop is initiated by first highlighting an object (“selecting” it), then holding the left mouse button down while moving (“dragging”) it, then releasing the left mouse button to “drop” the object. FIG. 5 illustrates the steps 300 for a process to implement drag and drop according to a preferred embodiment of the present invention. Referring to FIGS. 1 and 5, first, in the step 301, a user moves his finger along the finger image sensor 101 to move the onscreen cursor controlled by the finger image sensor 101, and point the onscreen cursor at an object to be selected. Next, in the step 303, the object is selected by, for example, initiating a single mouse click on the finger image sensor 101, such as described above in reference to FIG. 3. Next, in the step 305, the selected object is captured. In one embodiment, capturing is performed by placing the finger on the finger image sensor relatively stationary (e.g., moving the finger in the x-direction by no more than GX units and in the y-direction by no more than GY units) for longer than a duration TG1. It will be appreciated that if the finger is moved within the window of TG1, then the cursor is moved without capturing the selected object.

Next, in the step 307, if the captured object is dragged by moving the finger across the finger image sensor 101 in a direction corresponding to the direction that the onscreen object is to be moved. Finally, in the step 309, when the captured object is at the location to be dropped, it is dropped by tapping the finger image sensor 101 as described above to emulate a single click.

The steps 300 are sufficient to complete the entire drag and drop operation. To uncapture an item and hence not to start dragging the object, multiple methods are available. In different embodiments, a single click, a regional click on a different region (e.g., L, C, and R), or simply repeating the step 305 will uncapture the selected object.

In the preferred embodiment, GX and GY are both equal to 10 mm, though they can range from 0 mm to 100 mm in alternative embodiments. Preferably, TG1 has a value between 10 ms and 2 seconds. Most preferably, TG1 is set to 500 ms.

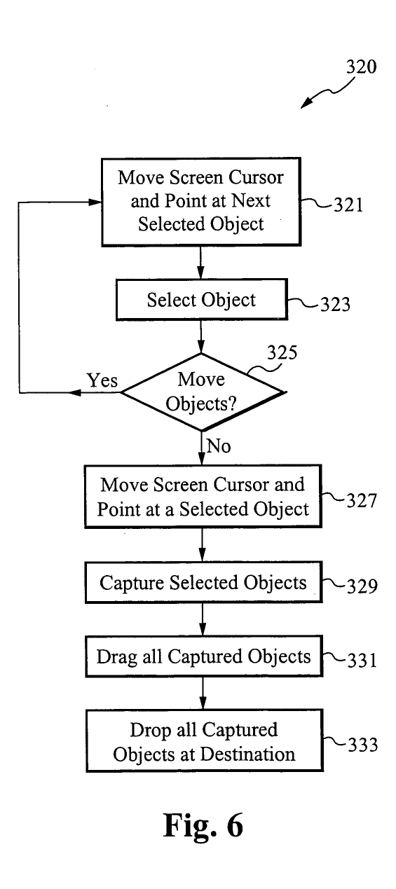

In further embodiments of the present invention, multiple objects can be selected for drag and drop. FIG. 6 shows the steps 320 of a process for dragging and dropping multiple objects in accordance with the present invention. Referring now to FIGS. 1 and 6, first, in the step 321, the finger image sensor 101 is used to move the screen cursor to point to the target object to be selected. Next, in the step 323, the target object is selected with a left mouse click. In the step 325, the process determines whether more objects are to be selected. If more objects are to be selected, the process loops back to the step 321; otherwise, the process continues to the step 327.

In the step 327, the onscreen cursor is moved to point at any one or more of the selected objects. Next, in the step 329, the selected objects are then captured by placing the finger on the finger image sensor 101 relatively stationary (moving less than GX and GY units) for longer than TG1 time units. It will be appreciated that by moving the finger within TG1 units, the cursor is moved without capturing the selected objects. In the step 331, all the selected objects are dragged by moving the finger across the finger image sensor 101 in the direction of the destination location. Finally, in the step 333, all the selected and dragged objects are dropped at the destination with a right click.

In another embodiment, different timing parameters for regional clicks are used to tune the drag and drop behavior. For example, the TG1 for the left region is very short, resulting in a fast capture, while the TG1 for the right region is relatively longer, resulting in a slower capture.

Embodiments emulating drag and drop do not require a keyboard to select multiple items. Moreover, lifting the finger multiple times is allowed.

It will be appreciated that objects can be selected and deselected during a drag-and-drop function in other ways in accordance with the present invention. For example, in one alternative embodiment, an object is selected when a user rotates or rolls his finger along the fingerprint image sensor in a predetermined manner. After the object has been moved to its destination, such as described above, it is then deselected when the user rotates or rolls his finger along the fingerprint image sensor. Any combination of finger movements along the fingerprint image sensor can be used to select and deselect objects in accordance with the present invention. For example, the selection and deselection functions can both be triggered by similar finger movements along the fingerprint image sensor (e.g., both selection and deselection are performed when the user rotates his finger along the fingerprint image sensor in a predetermined manner), or they can be triggered by different finger movements (e.g., selection is performed when the user rotates his finger along the fingerprint image sensor and deselection is performed when the user rolls his finger along the fingerprint image sensor, both in a predetermined manner).

It will be appreciated that while fingerprint image sensors have been described to emulate mouse buttons associated with a drag-and-drop function, fingerprint image sensors can be configured in accordance with the present invention to emulate mouse buttons associated with any number of functions, depending on the application at hand.

The above embodiments are able to be implemented in any number of ways. For example, the process steps outlined in FIGS. 3-6 are able to be implemented in software, as a sequence of program instructions, in hardware, or in any combination of these. It will also be appreciated that while the above explanations describe using finger images to emulate mouse and other functions, other images can also be used in accordance with the present invention. For example, a stylus, such as one used to input data on a personal digital assistant, can be used to generate data patterns that correspond to a patterned image and that are captured by a fingerprint image sensor. The data patterns can then be used in accordance with the present invention to emulate mouse operations, such as described above. It will be readily apparent to one skilled in the art that various modifications may be made to the embodiments without departing from the spirit and scope of the invention as defined by the appended claims.

1. A system for emulating mouse operations comprising:
a. a finger image sensor for capturing images relating to a finger and generating finger image data;
b. a controller configured to receive the finger image data and generate movement and presence information related to the finger on the finger image sensor; and
c. an emulator configured to receive the movement and presence information, determine durations corresponding to the presence of the finger on the finger image sensor, and generate data corresponding to a mouse operation.

2. The system of claim 1, wherein the finger image sensor comprises one or more logical regions each corresponding to a positional mouse button.

3. The system of claim 2, wherein the emulator is configured to determine that a finger is off the finger image sensor for a predetermined duration and that the finger is maintained within an area of a first region from the one or more logical regions for a time within a predetermined range of durations.

4. The system of claim 3, wherein the emulator is configured to generate data corresponding to a single mouse click in the event that the finger is off the finger image sensor for at least a first predetermined duration, the finger is maintained within the area of the first region within a first predetermined range of durations, and the finger is off the finger image sensor for at least a second predetermined duration.

5. The system of claim 4, wherein the first predetermined duration is approximately 2 seconds, the first predetermined range of durations is 10 ms to 2 seconds, and the second predetermined duration is approximately 2 seconds.

6. The system of claim 4, wherein determining that the finger is maintained within the area of the first region comprises determining that the finger has moved no more than a first linear distance in a first direction within the first region and no more than a second linear distance in a second direction within the first region.

7. The system of claim 6, wherein the first linear distance and the second linear distance are approximately 10 mm.

8. The system of claim 6, wherein the first linear distance and the second linear distance are determined using a row-based correlation.

9. The system of claim 4, wherein the one or more logical regions comprise a left region corresponding to a left mouse button such that the single mouse click corresponds to a left mouse button click.

10. The system of claim 9, wherein the one or more logical regions further comprise at least one of a right region corresponding to a right mouse button and a center region corresponding to a center mouse button.

11. The system of claim 3, wherein the emulator is configured to generate data corresponding to a double mouse click in the event that the finger is off the finger image sensor for at least a first predetermined duration, the finger is maintained within an area of the first region within a first predetermined range of durations, the finger is off the finger image sensor for at least a second predetermined duration, the finger is maintained within the area of the first region within a third predetermined range of durations, and the finger is off the finger image sensor for at least a third predetermined duration.

12. The system of claim 4, wherein the emulator is further configured to generate data corresponding to relocating an object displayed on a screen.

13. The system of claim 12, wherein the data corresponding to relocating the object comprises:
a. first data corresponding to selecting the object using an onscreen cursor;
b. second data corresponding to capturing the object;
c. third data corresponding to moving the object along the screen; and
d. fourth data corresponding to unselecting the object.

14. The system of claim 13, wherein the first data are generated by moving the finger across the finger image sensor and tapping the finger image sensor, the second data are generated by placing and maintaining the finger within the area of the first region for a predetermined time, the third data are generated by moving the finger across the finger image sensor, and the fourth data are generated by tapping the finger on the finger image sensor.

15. The system of claim 1, further comprising an electronic device having a screen for displaying data controlled by the mouse operation, the electronic device any one of a portable computer, a personal digital assistant, and a portable gaming device.

16. The system of claim 1, wherein the finger image sensor is a swipe sensor.

17. The system of claim 16, wherein the swipe sensor is one of a capacitive sensor, a thermal sensor, and an optical sensor.

18. The system of claim 1, wherein the finger image sensor is a placement sensor.

19. A method of emulating a mouse operation comprising:
a. determining a sequence of finger placements on and off a finger image sensor and their corresponding durations; and
b. using the sequence and corresponding durations to generate an output for emulating the mouse operation.

20. The method of claim 19, wherein the finger image sensor comprises one or more regions, each region corresponding to a positional mouse button.

21. The method of claim 20, wherein determining a sequence of finger placements comprises:
a. determining that a finger is off the finger image sensor for at least a first predetermined duration;
b. determining that the finger is maintained within an area of a first region from the one or more regions within a first predetermined range of durations; and
c. determining that the finger is off the finger image sensor for at least a second predetermined duration.

22. The method of claim 21, wherein the mouse operation corresponds to a single mouse click.

23. The method of claim 22, wherein the first predetermined duration is approximately 2 seconds, the first predetermined range of durations is 10 ms to 2 seconds, and the second predetermined duration is approximately 2 seconds.

24. The method of claim 22, wherein determining that the finger is maintained within an area of the first region comprises determining that the finger has moved no more than a first linear distance in a first direction within the first region and no more than a second linear distance in a second direction within the first region.

25. The method of claim 24, wherein the first linear distance and the second linear distance are 10 mm.

26. The method of claim 24, wherein the first linear distance and the second linear distance are determined using a row-based correlation.

27. The method of claim 21, wherein the one or more regions comprise a left region corresponding to a left mouse button.

28. The method of claim 27, wherein the one or more regions further comprise at least one of a right region corresponding to a right mouse button and a center region corresponding to a right mouse button.

29. The method of claim 21, wherein determining a sequence of finger placements further comprises:
a. determining that the finger is maintained within the area of the first region within a third predetermined range of durations; and
b. determining that the finger is off the finger image sensor for at least a third predetermined duration.

30. The method of claim 29, wherein the mouse operation corresponds to a double mouse click.

31. The method of claim 19, wherein the finger image sensor is a swipe sensor.

32. The method of claim 31, wherein the swipe sensor is one of a capacitive sensor, a thermal sensor, and an optical sensor.

33. The method of claim 19, wherein the finger image sensor is a placement sensor.

34. The method of claim 20, further comprising determining a sequence of finger movements on the finger image sensor, wherein the output corresponds to data for relocating an object displayed on a screen.

35. The method of claim 34, wherein the sequence comprises:
a. moving the finger across the finger image sensor and tapping the finger image sensor, thereby generating data corresponding to selecting the object using an onscreen cursor;
b. placing the finger on the finger image sensor within an area of the first region from the one or more regions for a predetermined time, thereby generating data corresponding to capturing the object;
c. moving the finger across the finger image sensor, thereby generating data corresponding to moving the object; and
d. tapping the finger on the finger image sensor, thereby generating data corresponding to unselecting the object.

36. The method of claim 35, further comprising generating an audible sound corresponding to capturing the object.

37. The method of claim 34, wherein the sequence comprises:
a. performing one of rotating and rolling the finger along the finger image sensor, thereby generating data corresponding to select the object using an onscreen cursor;
b. moving the finger across the finger image sensor, thereby generating data corresponding to moving the object; and
c. performing one of rotating and rolling the finger along the finger image sensor, thereby generating data corresponding to unselect the object.

38. The method of claim 19, wherein the mouse operation is performed on an electronic computing platform selected from the group consisting of a portable computer, a personal digital assistant, and a portable gaming device.
